(19) United States
(12) Patent Application Publication
(10) Pub. No.: US 2007/0259203 A1
(43) Pub. Date: Nov. 8, 2007

(54) Coated Steel Strip

(75) Inventors: Udo Buecher, New South Wales (AU); Qiyang Liu, New South Wales (AU)

Correspondence Address: HAHN LOESER & PARKS, LLP, One GOJO Plaza, Suite 300, AKRON, OH, 44311-1076, US

(73) Assignee: BLUESCOPE STEEL LIMITED, Melbourne, Victoria (AU)

(21) Appl. No.: 10/596,058

(22) PCT Filed: Nov. 26, 2004
(86) PCT No.: PCT/AU04/01661

§ 371 Date: May 26, 2006

(30) Foreign Application Priority Data
Nov. 26, 2003 (AU) 2003906534

(51) Int. Cl. B23P 9/02

(52) U.S. Cl. 428/687; 427/360

(57) ABSTRACT

A method of forming a metal coated steel strip that has a brushed finish is disclosed. The method includes skin pass rolling a metal coated steel strip to suppress and/or obscure the spangles on the surface and thereafter brushing the skin passed rolled strip.

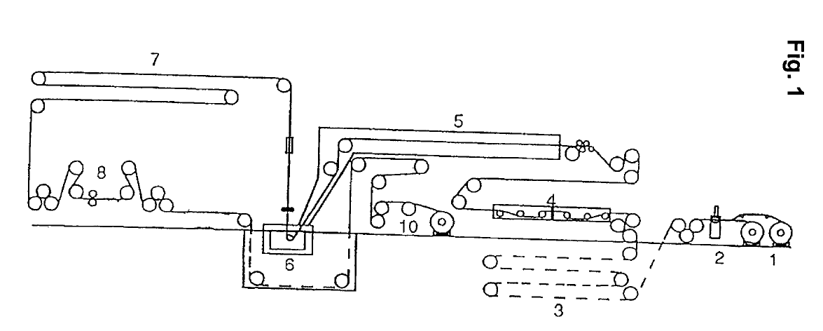

### BACKGROUND OF THE INVENTION

The present invention relates to a method of forming a metal (which term includes metal alloy) coated steel strip with a brushed finish.

The present invention relates more particularly, although by no means exclusively, to a method of forming a metallic coated steel strip in the form of a zinc/aluminum alloy or a zinc metal coated steel strip with a brushed finish.

U.S. Pat. No. 6,440,582 in the name of Bethlehem Steel Corporation (“BSC”) discloses a method of forming a zinc/aluminium alloy coated steel strip that has an advantageous appearance of brushed stainless steel.

The BSC method requires that the zinc/aluminium alloy coated steel strip have a minimum spangle or grain (hereinafter referred to as “spangle”) size.

Specifically, the BSC method includes coating steel strip in a molten bath of zinc/aluminium alloy that is modified with grain refiner compounds, such as selected borides, carbides and aluminides, which minimize the spangle size of the resultant zinc/aluminium alloy coating of the coated steel strip that emerges from the coating bath.

The use of the above grain refiner compounds in a hot dipped coating bath can be inconvenient because of the consequential delays and costs in production change-over.

The applicant has developed an alternative method of forming a zinc/aluminium alloy coated steel strip that has a brushed finish.

### SUMMARY OF THE INVENTION

The method of the present invention is not confined to zinc/aluminium alloy coated steel strip and extends to any hot dip metallic layer that exhibits spangles.

The method of the present invention does not require that the zinc/aluminium coated steel strip have a minimum spangle size and, specifically, does not require the addition of grain refiner compounds to a hot dip molten bath of zinc/aluminium alloy.

According to the present invention there is provided a method of forming a metal coated steel strip that has a brushed finish which comprises the steps of:
(a) passing steel strip through a molten bath of coating metal and forming a coating of metal having spangles on at least one surface of the strip;
(b) skin pass rolling the metal coated steel strip to suppress and/or obscure the spangles on the surface; and
(c) brushing the skin passed rolled metal coated steel strip.

The metal coating may be a zinc/aluminium alloy or a zinc metal or any other alloy or metal that forms spangles. The alloy or metal may include known additions used to promote spangle formation.

The brushed finish of the metal coated steel strip makes it suitable for a wide range of end-use applications in an unpainted form.

Whilst it is known to skin pass roll zinc/aluminium coated steel strip, the conventional purpose of skin pass rolling is to condition the coated strip surface (with minimal thickness reduction) to smooth the surface and to flatten surface defects, such as pinholes and surface dross, when such surface defects are present.

Skin pass rolling is necessary for and usually confined to situations in which the zinc/aluminium alloy coated steel strip is to be used for subsequent processing in a paint coating line.

The applicant is not aware of the use of skin pass rolling metal coated steel strip, including zinc/aluminium alloy coated steel strip, for the purpose of suppressing and/or at least partially obscuring the spangled surface of the coated strip.

The step of skin pass rolling the metal coated steel strip may include using rolls having a surface roughness of Ra of at least 0.4 microns.

Preferably the surface roughness is in the range of 2 to 3.5 microns.

The rolls may have a surface roughness of up to 4.5 microns. However, it is noted that even higher surface roughness values can produce the desired effect, although the rolls may impart excessive texture to the metal coated strip.

The step of brushing the skin pass rolled metal coated steel strip may be carried out by any suitable means, such as a rotary brushing roll. Well known methods of brushing metals on an industrial scale may, in some embodiments, be used.

Preferably the method further includes a step of forming a transparent or translucent coating of a clear paint or lacquer on the skin pass rolled metal coated steel strip.

The clear paint coat may, for example, be selected from finishes, such as, gloss, semi-gloss, low sheen or micro-wrinkle clear paint in order to further control additional suppression and/or obscuring of spangle appearance.

The coating may optionally be slightly pigmented, yet still transparent or translucent, to provide an appearance having a particular weak colour or hue.

Specifically pigments in the substantially clear paint, such as, for example, pearlescent, metallic pigment, metallic flake or other specialty effect pigment may be used in low quantities to enhance the visual appearance of the product.

According to the present invention there is also provided metal coated steel strip that has a brushed finish made by the above-described method.

The present invention is described further by way of example with reference to the accompanying schematic drawing of one embodiment of a continuous production line for producing brushed zinc/aluminium alloy coated steel strip in accordance with the method of the present invention.

### BRIEF DESCRIPTION OF THE DRAWINGS

With reference to the drawing, in use, coils of cold rolled steel strip are uncoiled at an uncoiling station 1 and successive uncoiled lengths of strip are welded end to end by a welder 2 and form a continuous length of strip.

### DETAILED DESCRIPTION OF THE INVENTION

The strip is then passed successively through an accumulator 3, a strip cleaning section 4 and a furnace assembly 5. The furnace assembly 5 includes a preheater, a strip preheating reducing furnace, and a strip reducing furnace.

The strip is heat treated in the furnace assembly 5 by careful control of process variables including: (i) the temperature profile in the furnaces, (ii) the reducing gas concentration in the furnaces, (iii) the gas flow rate through the furnaces, and (iv) strip residence time in the furnaces (i.e. line speed).

The process variables in the furnace assembly 5 are controlled so that the strip has required mechanical properties, oxide coatings are removed from the surface of the strip, and residual oils and iron fines are removed from the surface of the strip.

The heat treated strip is then passed via an outlet snout downwardly into and through a bath of molten coating metal, namely zinc/aluminium alloy, held in a coating pot 6 and is coated with zinc/aluminium alloy.

The molten bath does not contain grain refiner compounds such as, by way of example, the compounds disclosed in the above-mentioned BSC U.S. patent.

The zinc/aluminium alloy is maintained molten in the coating pot by the use of heating inductors (not shown).

Within the bath the strip passes around a sink roll and is taken upwardly out of the bath.

After leaving the coating bath 6 the zinc/aluminium alloy coated strip passes vertically through a gas wiping station (not shown) at which its coated surfaces are subjected to jets of wiping gas to control the thickness of the coating.

The zinc/aluminium alloy coated strip is then passed through a cooling section 7 and is subjected to forced air-cooling. The surfaces of the zinc/aluminium alloy coatings on the strip comprise spangles of standard size.

The cooled, zinc/aluminium alloy coated strip is then passed through a rolling section 8 that skin pass rolls the surface of the strip. The rolling conditions, particularly the surface roughness of the rolls, are selected so that the skin pass rolling alters the spangled surfaces to the extent that the spangles are obscured and/or at least partially suppressed.

The skin pass rolled zinc/aluminium alloy coated strip is thereafter coiled at a coiling station 10.

The coiled skin pass rolled zinc/aluminium alloy coated strip is transferred to a separate line and is uncoiled and passed through a brushing station (not shown) at which rotary brushes brush the surfaces of the strip, with the result that the surfaces have an appearance that is similar to brushed stainless steel or brushed aluminium.

The brushed skin pass rolled zinc/aluminium alloy coated strip is thereafter coiled at a coiling station (not shown).

The coiled brushed skin pass rolled zinc/aluminium alloy coated strip is transferred to a separate line and optionally is passed firstly to a cleaning and drying station (not shown).

The strip is then passed to a coating station (not shown) at which a clear paint coating is applied to the strip. The clear paint coat is substantially transparent or translucent and may contain decorative or functional pigments or fillers. Silica is an example of a functional filler which, among many other materials or methods, may be used to control gloss, or light scattering through the coating. An example of a decorative pigment is finely dispersed metallic flake. Another example is a light dye. Either of which may provide a specific visual effect or a specific small colour shift or impart a specific finished product hue.

The painted coated strip is then passed to a paint curing station (not shown).

The strip is then passed to a cooling station (not shown) at which the strip is water quenched.

The strip is then passed to a drying station (not shown) and dried and thereafter to a coiling station (not shown) and coiled at the station.

Many modifications may be made to the embodiment described above without departing from the spirit and scope of the present invention.

By way of example, whilst the embodiment is described in the context of producing brushed zinc/aluminium alloy coated steel strip, the present invention is not so limited and extends to producing brushed steel strip that is coated with any metal coating that forms spangles.

The reference to any prior art in this specification is not, and should not be taken as, an acknowledgement or any form of suggestion that the prior art forms part of the common general knowledge in Australia.

1. A method of forming a metal coated steel strip that has a brushed finish which includes the steps of:
(a) passing steel strip through a molten bath of metal and forming a coating of metal having spangles on at least one surface of the strip;
(b) skin pass rolling the metal coated steep strip to at least one of suppress and obscure the spangles on the surface; and
(c) brushing the skin passed rolled metal coated steel strip.

2. The method defined in claim 1 wherein step (b) of skin pass rolling the metal coated steel strip includes providing rolls having a surface roughness Ra of at least 0.4 microns.

3. The method defined in claim 1 wherein step (b) of skin pass rolling the metal coated steel strip includes providing rolls having a surface roughness Ra of 2 to 3.5 microns.

4. The method defined in claim 1 wherein step (c) of brushing the skin pass rolled metal coated steel strip includes providing a rotary brushing roll.

5. The method defined in claim 1, further comprising: forming a coating of at least one of a clear paint and lacquer on the skin pass rolled metal coated steel strip, the coating being one of transparent and translucent.

6. The method defined in claim 5 wherein the clear paint coat has a finish selected from the group consisting of gloss, semi-gloss, low sheen and micro-wrinkle.

7. The method defined in claim 5 wherein the clear paint coat is slightly pigmented, providing an appearance having one of a selected weak colour or hue.

8. The method defined in claim 1 wherein the metal is a zinc/aluminium alloy.

9. The method defined in claim 1 wherein the metal is zinc with minor amounts of additions used for spangle formation.

10. A metal coated steel strip that has a brushed finish made by the method defined in claim 1.

11. The metal coated steel strip defined in claim 10 wherein the metal is a zinc/aluminium alloy.

12. The metal coated steel strip defined in claim 10 wherein the metal is zinc with minor amounts of additions used for spangle formation.

13. The metal coated steel strip defined in claim 10 further including a clear paint coating.

14. A metal coated steel strip comprising:
a steel strip; and
a brushed, skin pass rolled metal coating on at least one side of the steel strip.

15. The metal coated steel strip defined in claim 14, where the brushed, skin pass rolled metal coating at least one of suppresses spangles therein or obscures spangles therein.

16. The metal coated steel strip defined in claim 14, further comprising a non-opaque coating on the brushed, skin pass rolled metal coating.

17. The metal coated steel strip defined in claim 16, wherein the non-opaque coating comprises a coating selected from the group consisting of clear paint and lacquer.

18. The metal coated steel strip defined in claim 16, wherein the non-opaque coating is a clear paint having a finish selected from the group of finishes consisting of gloss, semi-gloss, low sheen and micro-wrinkle.
